(19) United States
(12) Patent Application Publication
(10) Pub. No.: US 2019/0054427 A1
(43) Pub. Date: Feb. 21, 2019

(54) METHODS FOR REGENERATING AGED CARBON MOLECULAR SIEVE MEMBRANES

(71) Applicant: Georgia Tech Research Corporation, Atlanta, GA (US)

(72) Inventors: Chen Zhang, Atlanta, GA (US); William John Koros, Atlanta, GA (US)

(21) Appl. No.: 16/051,748

(22) Filed: Aug. 1, 2018

Related U.S. Application Data
(60) Provisional application No. 62/545,737, filed on Aug. 15, 2017.

(51) Int. Cl. B01D 71/02; B01J 27/20; B01J 29/035

(52) U.S. Cl. CPC B01D 71/021; B01D 69/088; B01J 29/035; B01J 27/20

(57) ABSTRACT

Embodiments of the present disclosure relate to methods of treating carbon molecular sieve (CMS) membranes, and in particular CMS hollow fiber membranes, that have undergone aging-induced permeance/permeability loss. By treating aged CMS membranes in accordance with embodiments of the present disclosure, the CMS membranes may be regenerated such that the aging-induced permeance/permeability loss is reversed and the permeance/permeability of the CMS membrane is increased. In some embodiments, the permeance/permeability of the treated CMS membrane may be increased to such a degree that the permeance/permeability of the regenerated CMS membrane is at least as high as the original permeance/permeability of the CMS membrane prior to aging-induced permeance/permeability loss.

This application claims priority to U.S. Provisional Patent Application No. 62/545,737, filed Aug. 15, 2017, the entirety of which is incorporated by reference herein.

### SUMMARY OF THE INVENTION

Physical aging is seen as a challenge for application of carbon molecular sieve membranes. Physical aging is believed to be primarily due to micropore densification and usually leads to undesirable permeability or permeance loss over time. An example of a typical permeance loss over time is shown in FIG. 1, which has been reproduced from Xu, L. et al. Carbon 80, 155-166, (2014). The present disclosure reveals methods to recover lost permeance in aged CMS membranes by exposure to selected strongly sorbing penetrants.

Embodiments of the present disclosure relate to methods of treating carbon molecular sieve (CMS) membranes, and in particular CMS hollow fiber membranes, that have undergone aging-induced permeance/permeability loss. By treating aged CMS membranes in accordance with embodiments of the present disclosure, the CMS membranes may be regenerated such that the aging-induced permeance/permeability loss is reversed and the permeance/permeability of the CMS membrane is increased. In some embodiments, the permeance/permeability of the treated CMS membrane may be increased to such a degree that the permeance/permeability of the regenerated CMS membrane is at least as high as the original permeance/permeability of the CMS membrane prior to aging-induced permeance/permeability loss.

Embodiments of the method comprise regenerating an aged CMS membrane that has undergone aging-induced permeance loss by treating the aged CMS membrane so as to obtain a regenerated CMS membrane, the regenerated CMS membrane having a permeance that is greater than the permeance of the aged CMS membrane. The treatment of the aged CMS membrane comprises exposing the aged CMS membrane to a regeneration or treatment fluid comprising one or more regeneration agents. The regeneration agent may desirably have a high polarizability. For instance, in some embodiments the treatment fluid may comprise a regeneration agent having a polarizability of at least 2 Å³, alternatively the treatment fluid may comprise a regeneration agent having a polarizability of at least 2.5 Å³. In some embodiments, for example, the treatment fluid may comprise carbon dioxide, ethylene, propylene, or a combination thereof. The regeneration treatment may be performed by subjecting a first side of the aged CMS membrane to the treatment fluid at a high pressure while maintaining the opposite side of the CMS membrane at a relatively low pressure, e.g. at atmospheric pressure. Alternatively, the regeneration treatment may be performed by exposing both side of the membrane to the high-pressure treatment fluid. The exact pressure of the treatment fluid and the duration of the regeneration treatment may be selected in order to efficiently obtain a desired degree of regeneration.

In some embodiments, the permeance of the regenerated CMS membrane may be at least 1.5 times the permeance of the aged CMS membrane (a 150% increase), alternatively the permeance of the regenerated CMS membrane may be at least double the permeance of the aged CMS membrane (a 200% increase), alternatively the permeance of the regenerated CMS membrane may be at least three times the permeance of the aged CMS membrane (a 300% increase), alternatively the permeance of the regenerated CMS membrane may be at least four times the permeance of the aged CMS membrane (a 400% increase).

In some embodiments, the permeance of the regenerated CMS membrane may be at least as high as the original permeance of the CMS membrane prior to aging-induced permeance loss (i.e. the permeance of the as-prepared CMS membrane). For instance, the permeance of the regenerated CMS membrane may be at least 10% greater than the original permeance, alternatively the permeance of the regenerated CMS membrane may be at least 15% greater than the original permeance, alternatively the permeance of the regenerated CMS membrane may be at least 20% greater than the original permeance, alternatively the permeance of the regenerated CMS membrane may be at least 25% greater than the original permeance. Additionally, the selectivity of the regenerated CMS membrane may be similar to the original selectivity of the CMS membrane prior to aging (i.e. the selectivity of the as-prepared CMS membrane). For instance, the selectivity of the regenerated CMS membrane may be within 80% of the original selectivity, alternatively the selectivity of the regenerated CMS membrane may be within 85% of the original selectivity, alternatively the selectivity of the regenerated CMS membrane may be within 90% of the original selectivity.

### BRIEF DESCRIPTION OF THE DRAWINGS

A clear conception of the advantages and features of one or more embodiments will become more readily apparent by reference to the exemplary, and therefore non-limiting, embodiments illustrated in the drawings:

FIG. 1 is a graph showing the typical aging-induced permeance drop of a CMS hollow fiber membrane. Specifically, FIG. 1 shows the time dependence of separation performance—specifically C₂H₄ permeance and C₂H₄/C₂H₆ selectivity—for a CMS hollow fiber membrane prepared by the pyrolysis of 6FDA-DAM.

FIG. 2 is an illustration showing the pore structures of the micropores and ultramicropores within a CMS membrane.

FIG. 3 is an illustration showing the typical bimodal pore size distribution of a CMS membrane.

FIG. 4 is an illustration showing the dilation and densification of micropores within a CMS membrane. λ indicates micropore dimension or penetrant jump length.

FIG. 5 is a graph of single-gases permeation for a CMS hollow fiber membrane at increasing pressures, showing a substantial permeance increase with condensable penetrants (e.g. CO₂, C₂H₄, and C₃H₆).

FIG. 6 is a schematic illustration of a high pressure gas permeation system, such as that used in embodiments of the regeneration process of disclosed herein.

FIG. 7 is a graph showing the CO₂/CH₄ separation performance of a CMS hollow fiber membrane before aging, after aging, and after treatment by an embodiment of the regeneration process described herein. The permeance results are plotted as solid data points. The separation factor results (i.e. selectivity results) are plotted as hollow data points. The vertical line at day 14 indicates the time when the CMS hollow fiber membranes were treated using an embodiment of the regeneration process disclosed herein. The performance results were measured using a 50/50 binary mixture of CO₂ and CH₄ at a feed pressure of about 200 psia and a temperature of 35° C.

### DETAILED DESCRIPTION OF THE INVENTION

Membranes are widely used for the separation of gases and liquids, including for example, separating acid gases, such as CO₂ and H₂S from natural gas. Gas transport through such membranes is commonly modeled by the sorption-diffusion mechanism. Specifically, gas molecules sorb into the membrane at the upstream, and finally desorb from the membrane at the downstream. Permeation of gas molecules through such membranes follows the solution-diffusion mechanism. Gas molecules dissolve at the high concentration (upstream) side of the membrane and diffuse through the membrane along a concentration gradient to the low concentration (downstream) side of the membrane.

Two intrinsic properties are commonly used to evaluate the performance of a membrane material; “permeability” and “selectivity.” Permeability is hereby defined as a measure of the intrinsic productivity of a membrane material; more specifically, it is the partial pressure and thickness normalized flux, typically measured in Barrer. Permeance, which is sometimes used in place of permeability, measures the pressure-normalized flux of a given compound. Selectivity, meanwhile, is a measure of the ability of one gas to permeate through the membrane versus a different gas; for example, the permeability of CO₂ versus CH₄, measured as a unit-less ratio.

The permeability of gas A is defined as the steady-state flux (N_{A}), normalized by trans-membrane partial pressure difference (Δp_{A}) and thickness of effective membrane selective layer (l):

$${P}_{A} = \frac{{N}_{A} \cdot l}{Δ {p}_{A}}$$

Permeability is traditionally given in the unit of Barrer:

$$1 Barrer = 1 \times {10}^{- 10} \frac{{cm}^{3} ( STP ) \cdot cm}{{cm}^{2} \cdot s \cdot cm Hg}$$

For asymmetric membranes, the thickness of effective membrane selective layer usually cannot be reliably determined. Therefore membrane productivity is described by permeance, which is simply the trans-membrane partial pressure normalized flux:

$$( \frac{{P}_{A}}{l} ) = \frac{{N}_{A}}{Δ {p}_{A}}$$

“Gas permeation unit” or GPU is usually used as the unit of permeance, which is defined as:

$$1 GPU = {10}^{- 6} \frac{{cm}^{3} ( STP )}{{cm}^{2} \cdot s \cdot cm Hg}$$

Ideal selectivity and separation factor are usually used to characterize the efficiency of a membrane to separate a faster-permeating species A from a slower-permeating species B. For single gas permeation, the ideal selectivity of the membrane is defined as the ratio of single gas permeabilities or permeances:

$${α}_{A / B} = \frac{{P}_{A}}{{P}_{B}} = \frac{( {P}_{A} / l )}{( {P}_{B} / l )}$$

When a gas mixture permeates through a membrane, the separation factor is written as:

$${α}_{AB} = \frac{( {y}_{A} / {y}_{B} )}{( {x}_{A} / {x}_{B} )}$$

Where y and x are mole fractions in the downstream and upstream side of the membrane.

Currently, polymeric membranes are well studied and widely available for gaseous separations due to easy processability and low cost. CMS membranes, however, have been shown to have attractive separation performance properties exceeding that of polymeric membranes. CMS membranes are typically produced through thermal pyrolysis of polymer precursors. Many polymers have been used to produce CMS membranes in fiber and dense film form. Polyimides have a high glass transition temperature, are easy to process, and have one of the highest separation performance properties among other polymeric membranes, even prior to pyrolysis.

Because carbon molecular sieve (CMS) membranes can be prepared to selectively permeate a first gas component from a gas mixture, they may be used for a wide range of gas separation applications. For instance, in various embodiments, CMS membranes may be configured for the separation of particular gases, including but not limited to CO₂ and CH₄, H₂S and CH₄, CO₂/H₂S and CH₄, CO₂ and N₂, O₂ and N₂, N₂ and CH₄, He and CH₄, H₂ and CH₄, H₂ and C₂H₄, ethylene and ethane, propylene and propane, and ethylene/propylene and ethane/propane, each of which may be performed within a gas stream comprising additional components. One of the many gas separation applications in which CMS membranes may be particularly suitable is in the separation of acid gas components—CO₂, H₂S, or a combination thereof—from a hydrocarbon-containing gas stream such as natural gas. The CMS membranes may be prepared so as to selectively sorb these acid gases, producing a permeate stream having an increased concentration of acid gases and a retentate stream having a reduced concentration of acid gases.

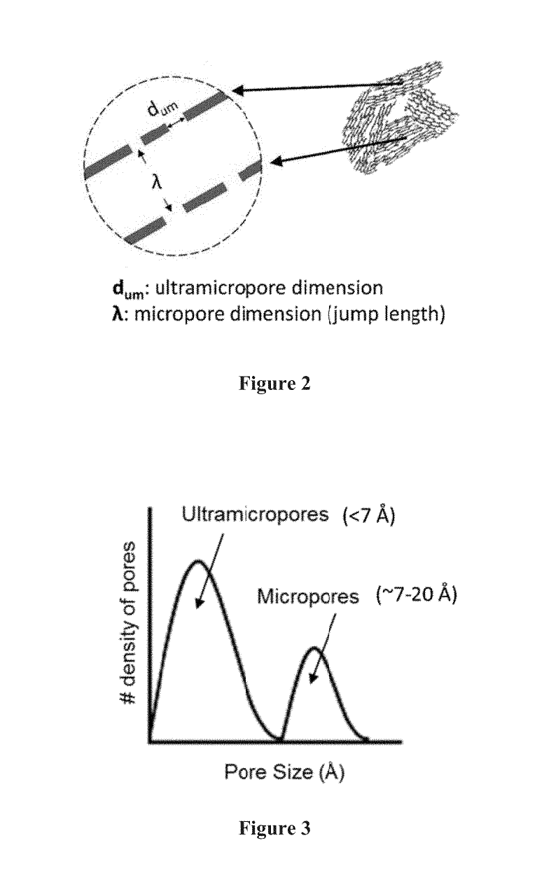

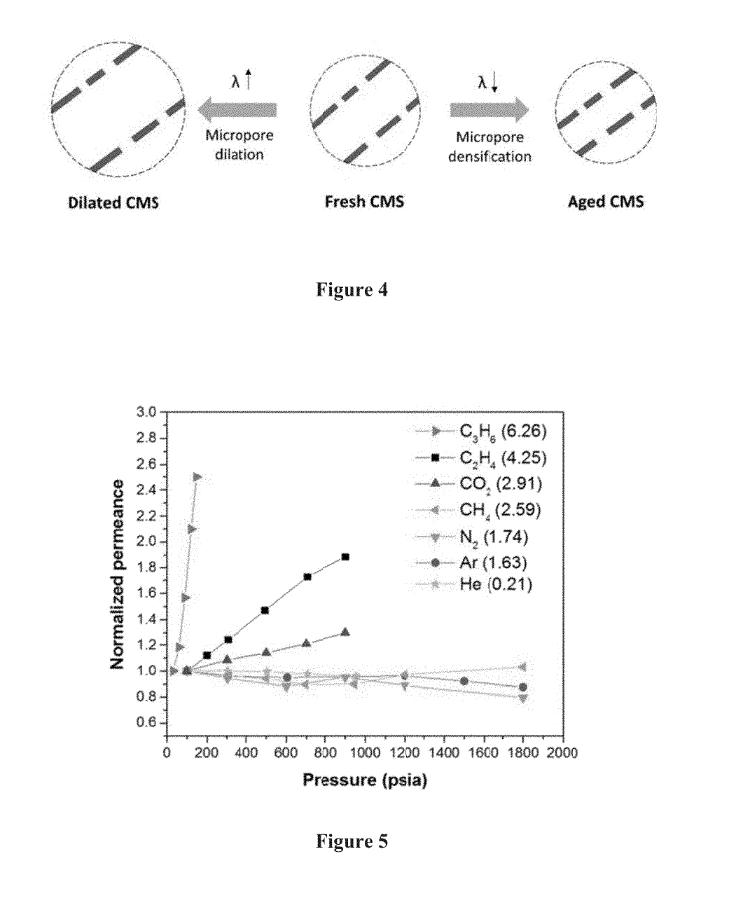

CMS pore structure is formed by packing imperfections of high disordered and disoriented sp²-hybridized graphene-like sheets. A visualization of a typical CMS porous structure is shown in FIGS. 2 and 3. As shown in FIGS. 2 and 3, the standard CMS porous structure can be represented by a bimodal pore size distribution. Micropores (7 Å<d<20 Å) provide the majority of surface area for sorption and are responsible for the membrane's high permeability. On the other hand, ultramicropores (d<7 Å) connecting micropores control diffusivity and consequently diffusion selectivity.

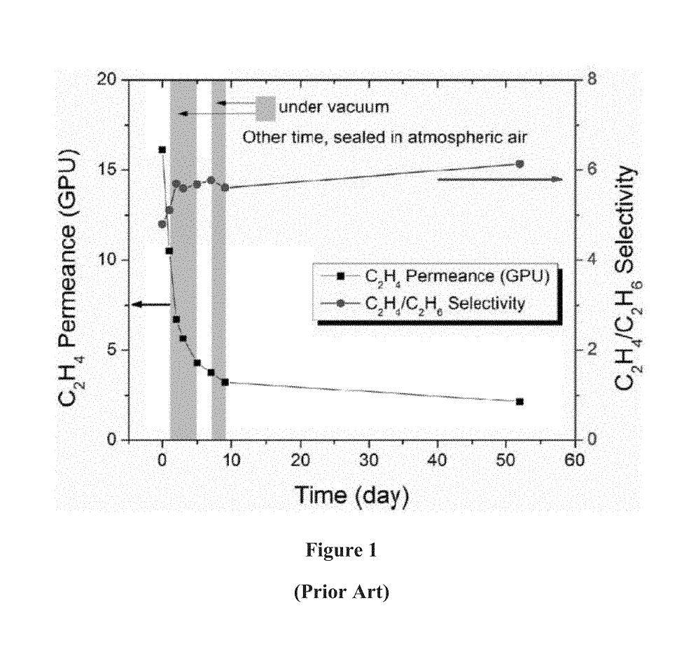

Good performance (permeance and selectivity) stability is critical to enable advanced membrane materials beyond fundamental characterizations. Despite offering attractive performance and scalability, CMS membranes are subject to physical aging typically defined to be a loss in membrane productivity. CMS is believed to be in a thermodynamically-unstable state after formation (pyrolysis), and its micropores densify over time. Such densification results in reduced micropore dimension (penetrant jump length) and drop in membrane permeability or permeance over time. In some cases, selectivity increase can also be observed. FIG. 1 shows time-dependent C₂H₄/C₂H₆ separation performance of a CMS hollow fiber membrane pyrolyzed from 6FDA-DAM precursor at 675° C. After being stored under vacuum/atmosphere for 60 days, membrane permeance dropped by over 80%.

The degree of physical aging and permeance loss is affected by several factors including precursor chemistry and pyrolysis conditions. In general, CMS membranes pyrolyzed from more “rigid” precursors (e.g. Matrimid®) at higher pyrolysis temperatures (e.g. 800° C.) with lower initial permeability or permeance tend to age less significantly over time. In addition to precursor chemistry and pyrolysis conditions, storage conditions can affect the degree of physical aging. For example, physical aging is known to accelerate if CMS membranes are stored under vacuum instead of at atmospheric conditions. CMS membranes typically show little or no permeance loss during active permeation and if stored under CO₂ at moderate pressure (e.g. 100 psia). Although physical aging and permeance loss can be prevented, the present disclosure introduces technologies that can regenerate aged CMS membranes and recover aging-induced permeance loss. More particularly, the present disclosure introduces methods to recover lost permeance in aged asymmetric CMS hollow fiber membranes by exposure to selected strongly sorbing penetrants.

### Asymmetric Hollow Fiber Membranes

Carbon molecular sieve (CMS) membranes have shown great potential for the separation of gases, such as for the removal of carbon dioxide (CO₂) and other acid gases from natural gas streams. Asymmetric CMS hollow fiber membranes are preferred for large scale, high pressure applications.

Asymmetric hollow fiber membranes have the potential to provide the high fluxes required for productive separation due to the reduction of the separating layer to a thin integral skin on the outer surface of the membrane. The asymmetric hollow morphology, i.e. a thin integral skin supported by a porous base layer or substructure, provides the fibers with strength and flexibility, making them able to withstand large transmembrane driving force pressure differences. Additionally, asymmetric hollow fiber membranes provide a high surface area to volume ratio.

Asymmetric CMS hollow fiber membranes comprise a thin and dense skin layer supported by a porous substructure. Asymmetric polymeric hollow fibers, or precursor fibers, are conventionally formed via a dry-jet/wet-quench spinning process, also known as a dry/wet phase separation process or a dry/wet spinning process. The precursor fibers are then pyrolyzed at a temperature above the glass transition temperature of the polymer to prepare asymmetric CMS hollow fiber membranes.

The polymer solution used for spinning of an asymmetric hollow fiber is referred to as dope. During spinning of a conventional precursor polymer fiber, the dope surrounds an interior fluid, which is known as the bore fluid. The dope and bore fluid are coextruded through a spinneret into an air gap during the “dry-jet” step. The spun fiber is then immersed into an aqueous quench bath in the “wet-quench” step, which causes a wet phase separation process to occur. After the phase separation occurs, the fibers are collected by a take-up drum and subjected to a solvent exchange process. An example of this process is shown in FIG. 1.

A conventional solvent exchange process involves two or more steps, with each step using a different solvent. The first step or series of steps involves contacting the precursor fiber with one or more solvents that are effective to remove the water in the membrane. This generally involves the use of one or more water-miscible alcohols that are sufficiently inert to the polymer. The aliphatic alcohols with 1-3 carbon atoms, i.e. methanol, ethanol, propanol, isopropanol, and combinations of the above, are particularly effective as a first solvent. The second step or series of steps involves contacting the fiber with one or more solvents that are effective to replace the first solvent with one or more volatile organic compounds having a low surface tension. Among the organic compounds that are useful as a second solvent are the C₅ or greater linear or branched-chain aliphatic alkanes.

The solvent exchange process typically involves soaking the precursor fibers in a first solvent for a first effective time, which can range up to a number of days, and then soaking the precursor fibers in a second solvent for a second effective time, which can also range up to a number of days. Where the precursor fibers are produced continuously, such as in a commercial capacity, a long precursor fiber may be continuously pulled through a series of contacting vessels, where it is contacted with each of the solvents. The solvent exchange process is generally performed at room temperature.

The precursor fibers are then dried by heating to temperature above the boiling point of the final solvent used in the solvent exchange process and subjected to pyrolysis in order to form asymmetric CMS hollow fiber membranes.

The choice of polymer precursor, the formation and treatment of the precursor fiber prior to pyrolysis, and the conditions of the pyrolysis all influence the performance properties of an asymmetric CMS hollow fiber membrane.

### Pyrolysis Conditions

Pyrolysis is advantageously conducted under an inert atmosphere. In some embodiments, the pyrolysis temperature may be between about 500° and about 1000° C., alternatively the pyrolysis temperature may be between about 500° and about 900° C.; alternatively, the pyrolysis temperature may be between about 500° and about 800° C.; alternatively, the pyrolysis temperature may be between about 500° and about 700° C.; alternatively, the pyrolysis temperature may be between about 500° and 650° C.; alternatively, the pyrolysis temperature may be between about 500° and 600° C.; alternatively, the pyrolysis temperature may be between about 500° and 550° C.; alternatively, the pyrolysis temperature may be between about 550° and about 700° C.; alternatively, the pyrolysis temperature may be between about 550° and about 650° C. alternatively the pyrolysis temperature may be between about 600° and about 700° C.; alternatively the pyrolysis temperature may be between about 600° and about 650° C. The pyrolysis temperature is typically reached by a process in which the temperature is slowly ramped up. For example, when using a pyrolysis temperature of 650° C., the pyrolysis temperature may be achieved by increasing the temperature from 50° C. to 250° C. at a ramp rate of 13.3° C./min, increasing the temperature from 250° C. to 635° C. at a ramp rate of 3.85° C./min, and increasing the temperature from 635° C. to 650° C. at a ramp rate of 0.25° C./min. Once the pyrolysis temperature is reached, the fibers are heated at the pyrolysis temperature for a soak time, which may be a number of hours.

The polymer precursor fibers may also be bundled and pyrolyzed as a bundle in order produce a large amount of modified CMS hollow fiber membranes in a single pyrolysis run. Although pyrolysis will generally be referred to in terms of pyrolysis of a precursor fiber, it should be understood that any description of pyrolysis used herein is meant to include pyrolysis of precursor fibers that are bundled as well as those that are non-bundled.

### Precursor Fibers

The asymmetric polymer precursor fiber may comprise any polymeric material that, after undergoing pyrolysis, produces a CMS membrane that permits passage of the desired gases to be separated, for example carbon dioxide and natural gas, and in which at least one of the desired gases permeates through the CMS fiber at different diffusion rate than other components.

For instance, the polymer may be any rigid, glassy polymer (at room temperature) as opposed to a rubbery polymer or a flexible glassy polymer. Glassy polymers are differentiated from rubbery polymers by the rate of segmental movement of polymer chains. Polymers in the glassy state do not have the rapid molecular motions that permit rubbery polymers their liquid-like nature and their ability to adjust segmental configurations rapidly over large distances (>0.5 nm). Glassy polymers exist in a non-equilibrium state with entangled molecular chains with immobile molecular backbones in frozen conformations. The glass transition temperature (Tg) is the dividing point between the rubbery or glassy state. Above the Tg, the polymer exists in the rubbery state; below the Tg, the polymer exists in the glassy state. Generally, glassy polymers provide a selective environment for gas diffusion and are favored for gas separation applications. Rigid, glassy polymers describe polymers with rigid polymer chain backbones that have limited intramolecular rotational mobility and are characterized by having high glass transition temperatures. Preferred rigid, glassy polymer precursors have a glass transition temperature of at least 200° C.

In rigid, glassy polymers, the diffusion coefficient tends to control selectivity, and glassy membranes tend to be selective in favor of small, low-boiling molecules. For example, preferred membranes may be made from rigid, glassy polymer materials that will pass carbon dioxide, hydrogen sulfide and nitrogen preferentially over methane and other light hydrocarbons. Such polymers are well known in the art and include polyimides, polysulfones and cellulosic polymers.

The polyimides are examples of rigid, glassy polymers that may be used as polymer precursor materials. Suitable polyimides include, for example, Ultem® 1000, Matrimid® 5218, P84, Torion®, 6FDA-DAM, 6FDA-DAM-DABA, 6FDA-DETDA-DABA, 6FDA/BPDA-DAM, 6FDA-6FpDA, and 6FDA-IPDA.

The polyimide commercially sold as Matrimid® 5218 is a thermoplastic polyimide based on a specialty diamine, 5(6)-amino-1-(4′ aminophenyl)-1,3-trimethylindane. Its structure is:

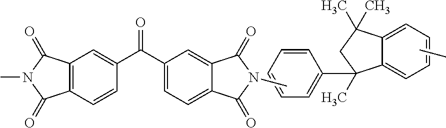

6FDA/BPDA-DAM is a polymer made up of 2,4,6-Trimethyl-1,3-phenylene diamine (DAM), 3,3,4,4-biphenyl tetracarboxylic dianhydride (BPDA), and 5,5-[2,2,2-trifluoro-1-(trifluoromethyl)ethylidene]bis-1,3-isobenzofurandione (6FDA), and having the structure:

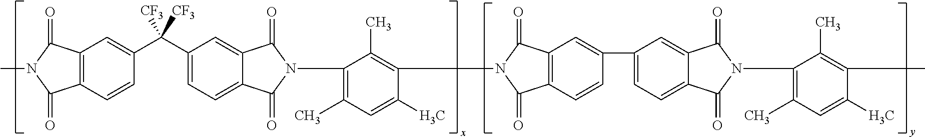

To obtain the above mentioned polymers one can use available sources or synthesize them. For example, such a polymer is described in U.S. Pat. No. 5,234,471, the contents of which are hereby incorporated by reference.

Although polyimide polymers are used in the examples, it is understood that the polyimides are merely examples of rigid, glassy polymers. Accordingly, the preparation of CMS membranes from the polyimides used in the examples is exemplary and representative of the preparation of CMS membranes from rigid, glassy polymers as a class of materials. Similarly, the use of CMS membranes prepared from polyimide precursors for the separation of gases, as demonstrated in the examples, is exemplary and representative of the gas separation performance of CMS membranes prepared from rigid, glassy polymers as a class of materials.

Examples of other suitable precursor polymers include polysulfones; poly(styrenes), including styrene-containing copolymers such as acrylonitrilestyrene copolymers, styrene-butadiene copolymers and styrene-vinylbenzylhalide copolymers: polycarbonates; cellulosic polymers, such as cellulose acetate-butyrate, cellulose propionate, ethyl cellulose, methyl cellulose, nitrocellulose, etc.; poly-amides and polyimides, including aryl polyamides and aryl polyimides; polyethers; polyetherimides; polyetherketones; poly(arylene oxides) such as poly(phenylene oxide) and poly(xylene oxide); poly(esteramide-diisocyanate); polyurethanes; polyesters (including polyarylates), such as poly(ethylene terephthalate), poly(alkyl methacrylates), poly(acrylates), poly(phenylene terephthalate), etc.; polypyrrolones; polysulfides; polymers from monomers having alpha-olefinic unsaturation other than mentioned above such as poly(ethylene), poly(propylene), poly(butene-1), poly(4-methyl pentene-1), polyvinyls, e.g., poly(vinyl chloride), poly(vinyl fluoride), poly(vinylidene chloride), poly(vinylidene fluoride), poly(vinyl alcohol), poly(vinyl esters) such as poly(vinyl acetate) and poly(vinyl propionate), poly(vinyl pyridines), poly(vinyl pyrrolidones), poly(vinyl ethers), poly(vinyl ketones), poly(vinyl aldehydes) such as poly(vinyl formal) and poly(vinyl butyral), poly(vinyl amides), poly(vinyl amines), poly(vinyl urethanes), poly(vinyl ureas), poly(vinyl phosphates), and poly(vinyl sulfates); polyallyls; poly(benzobenzimidazole); polyhydrazides; polyoxadiazoles; polytriazoles; poly(benzimidazole); polycarbodiimides; polyphosphazines; etc., and interpolymers, including block interpolymers containing repeating units from the above such as terpolymers of acrylonitrile-vinyl bromide-sodium salt of para-sulfophenylmethallyl ethers; and grafts and blends containing any of the foregoing. Typical substituents providing substituted polymers include halogens such as fluorine, chlorine and bromine; hydroxyl groups; lower alkyl groups; lower alkoxy groups; monocyclic aryl; lower acyl groups and the like. Other examples of precursor materials may include polymers with intrinsic microporosity (e.g. those disclosed in U.S. Pat. App. Pub. No. 20150165383), thermally-rearranged polymers (e.g. those disclosed in U.S. Pat. App. Pub. No. 20120329958), and mixed-matrix materials (e.g. those disclosed in U.S. Pat. App. Pub. No. 20170189866 A1).

The asymmetric polymer precursor fiber may be a composite structure comprising a first polymer material supported on a porous second polymer material. Composite structures may be formed by using more than one polymer material as the dope during the asymmetric hollow fiber spinning process.

### Regeneration of CMS Membranes

Embodiments of the present disclosure are directed to methods for regenerating aged carbon molecular sieve membranes. A carbon molecular sieve membrane which has undergone aging-induced permeance loss, and in some cases a CMS membrane which has undergone substantial aging-induced permeance loss, is provided. In some embodiments, for example, the aged CMS membrane may have lost at least 20% of its original permeance, alternatively the aged CMS membrane may have lost at least 30% of its original permeance, alternatively the aged CMS membrane may have lost at least 40% of its original permeance, alternatively the aged CMS membrane may have lost at least 50% of its original permeance, alternatively the aged CMS membrane may have lost at least 60% of its original permeance, alternatively the aged CMS membrane may have lost at least 70% of its original permeance.

The aging-induced permeance loss may have resulted from storage of the CMS membrane under regular atmospheric conditions, either intentionally or unintentionally. Because the present disclosure provides a method by which an aged CMS membrane may be regenerated, it is contemplated that, rather than storing a CMS membrane under conditions that prevent aging-induced permeance lost (such as under active permeation conditions), it may become more cost-effective to store a CMS membrane under atmospheric conditions or even under vacuum and then to regenerate the CMS membrane using the methods disclosed herein prior to its use in a gas separation application. After regeneration, the CMS membrane may either be immediately used for a gas separation application or it may then be stored (e.g. for a relatively short period of time) under active permeation conditions prior to use in a gas separation application.

The aged CMS membrane may be treated to exposing the aged CMS membrane to a treatment fluid comprising a one or more regeneration agents so as to obtain a regenerated CMS membrane. The treatment fluid may be a gas, a vapor, a liquid, or a supercritical fluid. In some embodiments, the treatment fluid may be a gas or a vapor.

The treatment fluid comprises one or more regeneration agents. The regeneration agent may be a condensable penetrant and preferably a condensable penetrant having a high polarizability. Without being bound by theory, it is believed that at high pressure, a regeneration agent having a high polarizability is strongly sorbed inside CMS micropores, thereby causing dilation of the CMS micropore structure. Dilation of the CMS micropore structure produces an increase in micropore dimensions and penetrant jump lengths. While it may be possible to bring about dilation of the CMS micropore structure using agents having low polarizability, the pressure that would be required to do so using those agents would be impractically high. Accordingly, use of a regeneration agent having a high polarizability allows for regeneration to occur at practically operable pressures.

In some embodiments, for example, the treatment fluid may comprise a regeneration agent having a polarizability of at least 2 Å³, alternatively the treatment fluid may comprise a regeneration agent having a polarizability of at least 2.5 Å³, alternatively the treatment fluid may comprise a regeneration agent having a polarizability of at least 2.6 Å³, alternatively the treatment fluid may comprise a regeneration agent having a polarizability of at least 2.7 Å³, alternatively the treatment fluid may comprise a regeneration agent having a polarizability of at least 2.8 Å³, alternatively the treatment fluid may comprise a regeneration agent having a polarizability of at least 2.9 Å³, alternatively the treatment fluid may comprise a regeneration agent having a polarizability of at least 3 Å³, alternatively the treatment fluid may comprise a regeneration agent having a polarizability of at least 4 Å³, alternatively the treatment fluid may comprise a regeneration agent having a polarizability of at least 5 Å³, alternatively the treatment fluid may comprise a regeneration agent having a polarizability of at least 6 Å³.

The treatment fluid may comprise, consist essentially of (i.e. be at least 90%), or consist of (i.e. be 100%) the one or more regeneration agents. In some embodiments, the treatment fluid may comprise CO₂, ethylene (C₂H₄), propylene, (C₃H₆) or a combination thereof. For example, the treatment fluid may comprise, consist essentially of, or consist of CO₂, ethylene, propylene, or a mixture of ethylene and propylene. Although carbon dioxide, ethylene, and propylene are used as examples, other regeneration agents—especially other regeneration agents having high polarizability—may be used without departing from the scope of the present disclosure. The treatment fluid may also comprise one or more carrier agents (e.g. carrier gases) in addition to the one or more regeneration agents.

The regeneration treatment may comprise subjecting the aged CMS membrane to a treatment fluid comprising a regeneration agent under relatively high pressure. In some embodiments, for instance, the first side of the aged CMS membrane may be exposed to the treatment fluid at a pressure of at least 200 psia, alternatively at least 500 psia, alternatively at least 800 psia, alternatively at least 1000 psia, alternatively at least 1200 psia, alternatively at least 1500 psia, alternatively at least 1600 psia, alternatively at least 1800. For example, the first side of the aged CMS membrane may be exposed to the treatment fluid at a pressure between about 100 psia and about 2000 psia, alternatively between about 200 psia and about 1800 psia, alternatively between about 200 psia and about 1600 psia, alternatively between about 200 psia and about 1500 psia. The second side of the aged CMS membrane may be maintained at a lower pressure than the first side so as to induce gas permeation through the membrane. In some embodiments, for instance, the second side of the aged CMS membrane may be held at substantially atmospheric pressure. In other embodiments, the second side of the aged CMS membrane may be held under vacuum. In alternative embodiments, both sides (i.e., both the first side and the second side) of the aged CMS membrane may be exposed to a treatment fluid comprising a regeneration agent under relatively high pressure, such as any of the pressures listed above.

The exact pressure(s) used may be selected based on the identity of the regeneration agent. Regeneration agents having higher polarizabilities may be used to efficiently treat the aged CMS membranes so as to bring about regeneration at lower pressures. For instance, when CO₂, which has a relatively high polarizability, is used as the regeneration agent, treatment at 1800 psia or less (at room temperature) may be sufficient to regenerate an aged CMS membrane. Where regeneration agents having lower polarizabilities are used (N₂ for example), however, treatment at higher pressures may be desired to regenerate the aged CMS membrane in a more efficient manner. Similarly, where regeneration agents having higher polarizabilites are used (propylene or ethylene for example), treatment at lower pressures may be used to regenerate the aged CMS membrane in a more efficient manner.

Depending on (a) the degree of aging-induced permeance loss that the aged CMS membrane has undergone and/or (b) the identity of the regeneration agent and fluid pressure employed, the regeneration treatment may be performed in a relatively short amount of time. For instance, in some embodiments, the regeneration treatment may be performed for two hours or less, alternatively the regeneration treatment may be performed for one hour or less, alternatively the regeneration treatment may be performed for 45 minutes or less, alternatively the regeneration treatment may be performed for 30 minutes or less, alternatively the regeneration treatment may be performed for 15 minutes or less.

The composition of the treatment fluid, the pressure(s) of the treatment fluid, and the duration of the treatment may be selected to obtain a desired degree of regeneration (i.e. a desired increase in permeance) in an efficient and economical manner. For instance, in some embodiments where CO₂ is used as the regeneration agent, the regeneration treatment may comprise subjecting the aged CMS membrane to a treatment fluid having a pressure of at least 1000 psia for a duration of at one hour or less, alternatively the regeneration treatment may comprise subjecting the aged CMS membrane to a treatment fluid having a pressure of at least 1200 psia for a duration of one hour or less, alternatively the regeneration treatment may comprise subjecting the aged CMS membrane to a treatment fluid having a pressure of at least 1500 psia for a duration of forty-five minutes or less, alternatively the regeneration treatment may comprise subjecting the aged CMS membrane to a treatment fluid having a pressure of at least 1600 psia for a duration of forty-five minutes or less, alternatively the regeneration treatment may comprise subjecting the aged CMS membrane to a treatment fluid having a pressure of at least 1500 psia for a duration of thirty minutes or less, alternatively the regeneration treatment may comprise subjecting the aged CMS membrane to a treatment fluid having a pressure of at least 1600 psia for a duration of thirty minutes or less, alternatively the regeneration treatment may comprise subjecting the aged CMS membrane to a treatment fluid having a pressure of at least 1800 psia for a duration of thirty minutes or less.

Depending on the degree of aging that the CMS membrane has undergone prior to treatment (note from FIG. 1 that a significant permeance drop occurs almost immediately), the regeneration process may be performed so that the resulting regenerated CMS membrane has a permeance that is significantly greater than that of the aged CMS membrane prior to the treatment. Throughout the present disclosure, the permeance of the regenerated CMS membrane may be compared to the permeance of the aged CMS membrane, the permeance of the original CMS membrane prior to aging, or both. Unless otherwise indicated, the permeance values are measured using the same method, equipment, and conditions. For instance, in Example 4 the permeances of the original CMS membrane, the aged CMS membrane, and the regenerated CMS membrane were all measured with the same constant-pressure permeation system and using a 50/50 molar CO₂/CH₄ mixture at 200 psia and 35° C.

In some embodiments, the regeneration process may result in a regenerated CMS membrane having a permeance that is at least 1.5 times the permeance of the aged CMS membrane. Alternatively, the regeneration process may result in a regenerated CMS membrane having a permeance that is at least 2 times the permeance of the aged CMS membrane. Alternatively, the regeneration process may result in a regenerated CMS membrane having a permeance that is at least 3 times the permeance of the aged CMS membrane. Alternatively, the regeneration process may result in a regenerated CMS membrane having a permeance that is at least 4 times the permeance of the aged CMS membrane. Alternatively, the regeneration process may result in a regenerated CMS membrane having a permeance that is at least 5 times the permeance of the aged CMS membrane.

For instance, in some embodiments, the CO₂ permeance of the regenerated CMS membrane (e.g. measured at a partial pressure of 100 psia and at 35° C.) may be at least 1.5 times the permeance of the aged CMS membrane, alternatively the CO₂ permeance of the regenerated CMS membrane may be at least 2 times the permeance of the aged CMS membrane, alternatively the CO₂ permeance of the regenerated CMS membrane may be at least 3 times the permeance of the aged CMS membrane, alternatively the CO₂ permeance of the regenerated CMS membrane may be at least 4 times the permeance of the aged CMS membrane, alternatively the CO₂ permeance of the regenerated CMS membrane may be at least 5 times the permeance of the aged CMS membrane.

The treatment fluid and the treatment conditions (e.g. pressure and duration) may also be selected so that the resulting regenerated CMS membrane has a permeance that is at least as high as the permeance of the original CMS membrane (i.e. the fresh CMS membrane prior to aging-induced permeance loss). For purposes of this comparison, note that if the permeance of the original CMS membrane is unknown, but the materials and conditions under which that original CMS membrane were prepared are known, one may prepare a new CMS membrane using the same materials and conditions in order to estimate the permeance of the original CMS membrane.

In some embodiments, for example, the permeance of the regenerated carbon molecular sieve membrane is at least as high as the original permeance of the fresh CMS membrane. In fact, the regenerated CMS membrane may have an increased permeance when compared to the original CMS membrane. For instance, the permeance of the regenerated carbon molecular sieve membrane may be at least 10% greater than the original permeance of the fresh CMS membrane. Alternatively, the permeance of the regenerated carbon molecular sieve membrane may be at least 15% greater than the original permeance of the fresh CMS membrane. Alternatively, the permeance of the regenerated carbon molecular sieve membrane may be at least 20% greater than the original permeance of the fresh CMS membrane. Alternatively, the permeance of the regenerated carbon molecular sieve membrane may be at least 25% greater than the original permeance of the fresh CMS membrane.

For instance, in some embodiments, the CO₂ permeance of the regenerated CMS membrane (e.g. measured at a partial pressure of 100 psia and at 35° C.) may be at least as high as the permeance of the original CMS membrane, alternatively the CO₂ permeance of the regenerated CMS membrane may be at least 10% greater than the permeance of the original CMS membrane, alternatively the CO₂ permeance of the regenerated CMS membrane may be at least 15% greater than the permeance of the original CMS membrane, alternatively the CO₂ permeance of the regenerated CMS membrane may be at least 20% greater than the permeance of the original CMS membrane, alternatively the CO₂ permeance of the regenerated CMS membrane may be at least 25% greater than the permeance of the original CMS membrane.

The treatment fluid and the treatment conditions (e.g. pressure and duration) may also be selected so that the resulting regenerated CMS membrane has a selectivity that is similar to the selectivity of the original CMS membrane (i.e. the fresh CMS membrane prior to aging-induced permeance loss). Unless otherwise indicated, the selectivity values of the regenerated CMS membrane and the original CMS membrane are measured using the same method, equipment, and conditions. For instance, in Example 4 the selectivities of the original CMS membrane and the regenerated CMS membrane were measured with the same constant-pressure permeation system using a 50/50 molar CO₂/CH₄ mixture at 200 psia and 35° C. Moreover, for purposes of this comparison, note that if the selectivity of the original CMS membrane is unknown, but the materials and conditions under which that original CMS membrane were prepared are known, one may prepare a new CMS membrane using the same materials and conditions in order to estimate the selectivity of the original CMS membrane.

In some embodiments, the selectivity of the regenerated carbon molecular sieve membrane may be within about 60% of the original selectivity of the fresh CMS membrane. Alternatively, the selectivity of the regenerated carbon molecular sieve membrane may be within about 70% of the original selectivity of the fresh CMS membrane. Alternatively, the selectivity of the regenerated carbon molecular sieve membrane may be within about 75% of the original selectivity of the fresh CMS membrane. Alternatively, the selectivity of the regenerated carbon molecular sieve membrane may be within about 80% of the original selectivity of the fresh CMS membrane. Alternatively, the selectivity of the regenerated carbon molecular sieve membrane may be within about 85% of the original selectivity of the fresh CMS membrane. Alternatively, the selectivity of the regenerated carbon molecular sieve membrane may be within about 90% of the original selectivity of the fresh CMS membrane.

For instance, in some embodiments, the CO₂/CH₄ selectivity of the regenerated CMS membrane (e.g. measured at 200 psia and 35° C.) may be within about 60% of the CO₂/CH₄ selectivity of the original CMS membrane, alternatively the CO₂/CH₄ selectivity of the regenerated CMS membrane may be within about 70% of the CO₂/CH₄ selectivity of the original CMS membrane, alternatively the CO₂/CH₄ selectivity of the regenerated CMS membrane may be within about 75% of the CO₂/CH₄ selectivity of the original CMS membrane, alternatively the CO₂/CH₄ selectivity of the regenerated CMS membrane may be within about 80% of the CO₂/CH₄ selectivity of the original CMS membrane, alternatively the CO₂/CH₄ selectivity of the regenerated CMS membrane may be within about 85% of the CO₂/CH₄ selectivity of the original CMS membrane, alternatively the CO₂/CH₄ selectivity of the regenerated CMS membrane may be within about 90% of the CO₂/CH₄ selectivity of the original CMS membrane.

### CMS Membranes and Gas Separation

Embodiments of the present disclosure are also directed to the asymmetric carbon molecular sieve hollow fiber membranes regenerated by any of the methods disclosed herein. Embodiments of the present disclosure are also directed to the use of the asymmetric CMS hollow fiber membranes regenerated as disclosed herein in processes for separating at least a first gas component and a second gas component.

In some embodiments, the process may comprise providing a carbon molecular sieve membrane regenerated by any of the processes disclosed herein and contacting a gas stream comprising at least a first gas component and a second gas component with the carbon molecular sieve membrane to produce i. a retentate stream having a reduced concentration of the first gas component, and ii. a permeate stream having an increased concentration of the first gas component. In some embodiments, the first gas component may be CO₂, H₂S, or a mixture thereof and the second gas component may be CH₄. For instance, in some embodiments, the process may comprise separating acid gas components from a natural gas stream by providing a carbon molecular sieve membrane regenerated by any of the process disclosed herein and contacting a natural gas stream containing one or more acid gas components with the carbon molecular sieve membrane to produce i. a retentate stream having a reduced concentration of acid gas components, and ii. a permeate stream having an increased concentration of acid gas components. Other gas pairings that can be separated using the CMS hollow fiber membranes regenerated as disclosed herein include CO₂ and N₂, O₂ and N₂, N₂ and CH₄, He and CH₄, H₂ and CH₄, H₂ and C₂H₄, ethylene and ethane, propylene and propane, and ethylene/propylene and ethane/propane.

### EXAMPLES

### Example 1—Preparation and Aging of Asymmetric CMS Hollow Fiber Membranes

Monolithic 6FDA/BPDA-DAM precursor hollow fiber membranes were formed using the “dry-jet/wet-quench” fiber spinning technique. Asymmetric CMS hollow fiber membranes were formed by controlled pyrolysis of the 6FDA/BPDA-DAM precursor hollow fibers using the heating protocol noted below under continuous purge (200 cc/min) of ultra-high-purity (UHP) argon.

Heating Protocol:

1) 50° C. to 250° C. (13.3° C./min)

2) 250° C. to 535° C. (3.85° C./min)

3) 535° C. to 550° C. (0.25° C./min)

4) Thermal soak at 550° C. for 120 min

5) Cool down naturally

The precursor hollow fiber was treated with 25 wt % VTMS prior to pyrolysis, as is described for instance in U.S. Pat. No. 9,211,504 B2 and U.S. patent application Ser. No. 14/501,884 (published as US 2015/0094445 A1), the entireties of which are incorporated herein by reference.

Following formation of the CMS hollow fiber membrane, a hollow fiber module was constructed using a CMS hollow fiber membrane. To age the CMS hollow fiber membrane, the hollow fiber module was stored in a vacuum oven at ambient temperature for two weeks. Both fiber shell and bore sides were exposed to vacuum during the storage.

### Example 2—Regeneration of Aged CMS Membranes

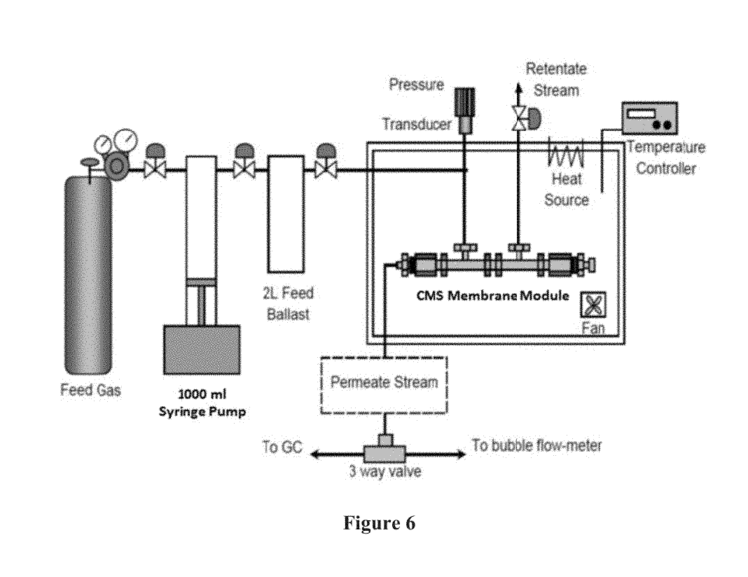

The aged CMS membranes were regenerated using a set-up such as that shown in FIG. 6. The membrane upstream was exposed to a pure CO₂ feed at 1800 psia. The membrane downstream was at 1 atm. The exposure was allowed to proceed for 30 mins. At the end of exposure, the membrane upstream was depressurized to 1 atm by slowly opening the retentate stream valve.

### Example 3—Single-Gas Permeation Characterization of CMS Hollow Fiber Membranes

Single-gas permeation measurements were performed at 35° C. with a constant-pressure permeation system, such as that shown in FIG. 6.

Single-gas permeation measurement is a useful tool to probe structural flexibility in membrane materials. For membrane materials whose sorption isotherm can be described by the dual-mode model (e.g. glassy polymers) or the Langmuir model (e.g. nanoporous materials), dilation is usually evidenced by increased permeability or permeance with increasing feed pressure. On the other hand, reduced permeability or permeance at higher feed pressure typically suggests that the material is consolidated, or densified.

To understand conditioning/dilation in CMS materials, we studied single-gas permeation in CMS hollow fiber membranes using penetrants (He, Ar, N₂, CH₄, CO₂, C₂H₄, and C₃H₆) with different polarizabilities. The results are shown in FIG. 5. FIG. 5 shows permeances for all studied penetrants up to 1800 psia normalized by the permeance measured at 100 psia (30 psia for C₃H₆) for the fresh (i.e., unaged) CMS hollow fiber membranes prepared in Example 1. For penetrants with polarizability less than 2 Å³ (He, Ar, and N₂), the CMS hollow fiber membrane showed slightly reduced permeance with increasing feed pressure, suggesting that the CMS was not dilated by these non-condensable penetrants. For CH₄ with slightly higher polarizability (2.59 Å³), membrane permeance first dropped as feed pressure increased from 100 to 900 psia, and then slightly increased as the membrane was further pressurized from 900 to 1800 psia. This suggests that the CMS membrane was moderately dilated at CH₄ feed pressure higher than 900 psia.

Interestingly, substantial permeance increase was seen for condensable penetrants with higher polarizability, i.e. CO₂ (polarizability: 2.91 Å³), C₂H₄ (polarizability: 4.25 Å³), and C₃H₆ (polarizability: 6.26 Å³). Notably, the percentage permeance increase becomes more pronounced with increasing penetrant polarizability (i.e. C₃H₆>C₂H₄>CO₂). Without being limited by theory, a possible explanation for these desirable and surprising results is that, due to micropore dilation, the micropore dimensions corresponding to jump lengths and sorption sites may be increased by the conditioning process. This increase could result in an increase in either (or both) sorption and diffusion coefficients, thereby increasing the permeability of the CMS. It appears that CMS ultramicropore dimensions are less affected by dilation than micropores, which is evidenced by the fact that very limited changes in CO₂/CH₄ separation factor have been seen for high pressure (up to 1800 psia) CO₂/CH₄ mixture permeation.

Physical aging is believed to reflect micropore densification and reduction in average micropore dimension. The fact that CMS can be dilated, as shown in FIG. 5, suggests that aged CMS membranes may be regenerated by purposefully dilating densified micropores. This can be achieved by exposing aged CMS membranes to condensable penetrants (e.g. CO₂, C₂H₄, and C₃H₆) that are able to dilate CMS micropores.

### Example 4—Mixed-Gas Permeation Characterization of Fresh, Aged, and Regenerated CMS Hollow Fiber Membranes

A CMS hollow fiber membrane prepared in Example 1 was purposefully aged for two weeks under vacuum prior to regeneration by exposure to high pressure CO₂ as described in Example 2. Equal-molar CO₂/CH₄ mixed-gas permeation measurements were performed at 35° C. with a constant-pressure permeation system, such as that shown in FIG. 6.

For CO₂/CH₄ mixture permeation, the upstream pressure was ˜200 psia and downstream was at atmospheric pressure. A syringe pump was used to maintain the high pressure at membrane upstream when needed. The stage-cut was kept below 1% by adjusting the flowrate of membrane retentate. A Varian 450 GC was used to measure the compositions of membrane permeates. Membrane separation factors were calculated based on at least three GC injections. Permeation measurements were done before aging, after aging, and after regeneration.

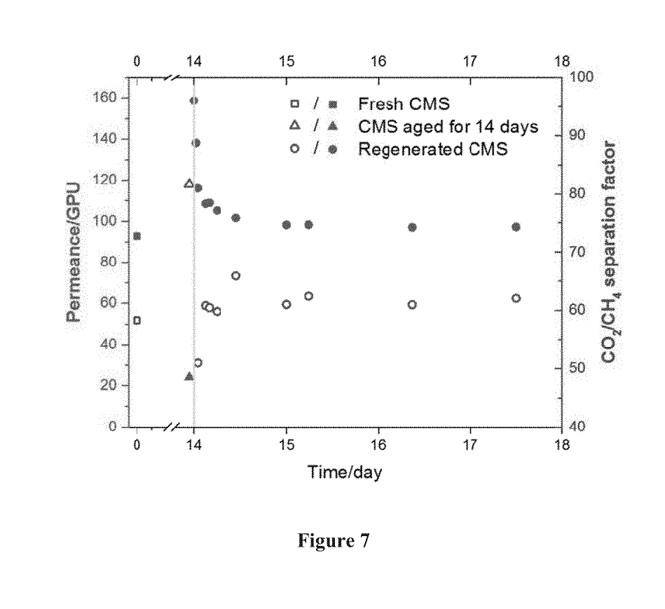

As shown in FIG. 7, the un-aged (fresh) CMS membrane initially showed CO₂ permeance of 93 GPU and CO₂/CH₄ separation factor of 58. After being aged for two weeks, CO₂ permeance dropped by 74% to 24 GPU and CO₂/CH₄ separation factor increased by 41% to 82. Immediately following regeneration, the membrane showed a CO₂ permeance of 159 GPU, which was 71% higher than the un-aged membrane and a CO₂/CH₄ separation factor of 51, which was 12% lower than the un-aged membrane.

Following the regeneration treatment, the CMS membrane was stored under a CO₂/CH₄ feed at moderate pressure (200 psia) to prevent new aging-induced permeance loss through active permeation. The CO₂ partial pressure of the feed was selected at 100 psia because it is known to suppress aging in CMS membranes during active permeation or storage. Within 24 hours following the regeneration treatment, both CO₂ permeance and CO₂/CH₄ separation factor were stabilized and were essentially identical to the permeance and selectivity values of the un-aged CMS membrane. These results demonstrate that high pressure CO₂ exposure was effective to regenerate aged CMS membrane by recovering aging-induced permeance loss.

The present disclosure provides methods to regenerate aged CMS membranes. The single-gas permeation measurements of Example 3 show that the CMS micropore is flexible and can be dilated by high pressure condensable penetrants. This suggests that aged CMS membranes can be regenerated by purposefully dilating densified micropores. The mixed-gas permeation measurements of Example 4 show that lost permeance in aged CMS hollow fiber membranes was effectively recovered by brief (30 mins) exposure to high pressure (1800 psia) pure CO₂. Although CO₂ is used as the example regeneration agent in the examples, other condensables (e.g. hydrocarbons) with high sorption capacity may also be used as regeneration agents.

It can be seen that the described embodiments provide unique and novel methods for regenerating CMS hollow fiber membranes for gas separation applications. While there is shown and described herein certain specific structures embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method for regenerating an aged carbon molecular sieve membrane comprising:
providing an aged carbon molecular sieve membrane which has undergone aging-induced permeance loss; and
treating the aged carbon molecular sieve membrane by exposing the aged carbon molecular sieve membrane to a treatment fluid comprising a regeneration agent so as to obtain a regenerated carbon molecular sieve membrane;
wherein the regenerated carbon molecular sieve membrane has a permeance that is greater than the permeance of the aged carbon molecular sieve membrane.

2. The method of claim 1, wherein the permeance of the regenerated carbon molecular sieve membrane is at least double the permeance of the aged carbon molecular sieve membrane.

3. The method of claim 2, wherein the permeance of the regenerated carbon molecular sieve membrane is at least three times the permeance of the aged carbon molecular sieve membrane.

4. The method of claim 3, wherein the permeance of the regenerated carbon molecular sieve membrane is at least four times the permeance of the aged carbon molecular sieve membrane.

5. The method of any one of claim 1, wherein prior to aging-induced permeance loss, the aged carbon molecular sieve membrane had an original permeance; and
wherein the permeance of the regenerated carbon molecular sieve membrane is at least as high as the original permeance.

6. The method of claim 5, wherein the permeance of the regenerated carbon molecular sieve membrane is at least 20% greater than the original permeance.

7. The method of claim 6, wherein the permeance of the regenerated carbon molecular sieve membrane is at least 25% greater than the original permeance.

8. The method of claim 5, wherein prior to aging-induced permeance loss, the aged carbon molecular sieve membrane had an original selectivity; and
wherein the regenerated carbon molecular sieve membrane has a selectivity that is within about 75% of the original selectivity.

9. The method of claim 1, wherein the aged carbon molecular sieve membrane is an asymmetric hollow fiber membrane.

10. The method of claim 1, wherein the aged carbon molecular sieve membrane was prepared by pyrolysis of a polyimide precursor fiber.

11. The method of any one of claim 1, wherein the regeneration agent has a polarizability of at least 2.7 Å³.

12. The method of claim 1, wherein the regeneration agent comprises CO₂, ethylene, propylene, or a combination thereof.

13. The method of claim 12, wherein the regeneration agent comprises CO₂.

14. The method of any one of claim 1, wherein the exposing comprises subjecting the aged carbon molecular sieve membrane to the treatment fluid at a pressure between 100 psia and 2000 psia.

15. The method of any one of claim 1, wherein the exposing is performed for one hour or less.

16. The method of any one of claim 1, wherein the exposing comprises subjecting the aged carbon molecular sieve membrane to the treatment fluid at a pressure between 200 psia and 1800 psia for 45 minutes or less.

17. A carbon molecular sieve hollow fiber membrane regenerated by claim 1.

18. A process for separating at least a first gas component and a second gas component comprising:
a. providing a carbon molecular sieve membrane regenerated by the method of claim 1; and
b. contacting a gas stream comprising at least a first gas component and a second gas component with the carbon molecular sieve membrane to produce
i. a retentate stream having a reduced concentration of the first gas component, and
ii. a permeate stream having an increased concentration of the first gas component.

19. The process of claim 18, wherein the first gas component is CO₂, H₂S, N₂, or a mixture thereof and the second gas component is CH₄.

20. The process of claim 18, wherein the first gas component is ethylene or propylene and the second gas component is ethane or propane.

21. The process of claim 18, wherein the first gas component is oxygen and the second gas component is nitrogen.

22. The process of claim 18, wherein the first gas component is carbon dioxide and the second gas component is nitrogen.

23. A process for separating acid gas components from a natural gas stream comprising:
a. providing a carbon molecular sieve membrane regenerated by the method of claim 1; and
b. contacting a natural gas stream having one or more acid gas components with the carbon molecular sieve membrane to produce
i. a retentate stream having a reduced concentration of acid gas components, and
ii. a permeate stream having an increased concentration of acid gas components.
